(19) United States
(12) Patent Application Publication
(10) Pub. No.: US 2005/0197735 A1
(43) Pub. Date: Sep. 8, 2005

(54) High input/output capacity storage system and subsystem

(76) Inventors: Dennis P. Martinez, Tucson, AZ (US); Tom O. Pringle, Tucson, AZ (US)

Correspondence Address: LAW OFFICE OF CHARLES W. PETERSON, JR. TUCSON, 11703 BOWMAN GREEN DR, suite 100, RESTON, VA, 20190, US

(21) Appl. No.: 10/794,115

(22) Filed: Mar. 5, 2004

(51) Int. Cl. G06F 7/00

(52) U.S. Cl. 700/214

(57) ABSTRACT

A high input/output (I/O) capacity, multi-frame storage subsystem, method of inserting/ejecting storage media in the storage subsystem and program product therefor. The storage media, e.g., magnetic tape in a physical volume, is placed into storage cells in a service bay before being inserted into the subsystem library or after being ejected from a data library in the subsystem. Whenever the service bay door is opened, the accessor is prevented from entering the service bay and tape cartridges may be inserted in the service bay storage cells or removed from the storage bay storage cells without pausing the subsystem.

### BACKGROUND OF THE INVENTION

1. Field of the Invention

The present invention is related to a mass storage device and more particularly to a mass storage device with removable storage media and methods of loading and unloading the removable storage media.

2. Background Description

Data storage systems administering data stored on removable storage media, such as an automated storage media (e.g., magnetic tape in tape cartridges) and retrieval library for storing and accessing removable storage media, are well known in the art. Typically, a data storage subsystem may include a number of frames, each with storage media volumes in storage cells that are accessible by an operator through a door in the particular frame. Other than for loading/unloading a small number (e.g., 10-20) of cells, state of the art data storage subsystems are paused during inserts and ejects; the frame door is opened at the storage media volumes to be inserted/ejected; the appropriate volumes are removed/loaded; the door is closed; and the data storage subsystem is returned to auto mode. A tape library configured for high capacity output can occupy as many as 100 storage cells. Thus, during the time that the cartridges are being removed/inserted, the subsystem is paused, pausing even areas/frames unaffected by the eject/insert.

One approach to improving high input/output (1/O) capacity subsystem efficiency is taught by “Dual Use Capacity Input/Output Station on an Automated Tape Library,” IBM Technical Disclosure Bulletin, Vol. 38, No. 5, May, 1995, hereinafter “TDB.” The TDB teaches an automated tape library with an attached device providing high I/O capacity. The device may increase subsystem power consumption and expands the footprint of the tape library, which may encroach on space that might be used otherwise, e.g., for aisles between subsystem units.

Thus, there is a need for a high I/O capacity storage subsystem, capable of inserting/ejecting storage media without pausing the storage subsystem and without expanding the subsystem footprint or increasing subsystem power consumption.

### SUMMARY OF THE INVENTION

It is a purpose of the invention to improve storage subsystem overall performance;

It is another purpose of the invention to improve high input/output capacity storage subsystem overall performance;

It is yet another purpose of the invention to insert/eject storage cartridges in high input/output capacity storage subsystems without pausing the storage subsystem during the insertion/ejection;

It is yet another purpose of the invention to insert/eject storage cartridges in high input/output capacity storage subsystems without pausing the storage subsystem during the insertion/ejection and without increasing storage subsystem footprint.

The present invention relates to a high input/output (I/O) capacity, multi-frame storage subsystem, method of inserting/ejecting storage media in the storage subsystem and program product therefor. The storage media, e.g., magnetic tape in a physical volume, is placed into storage cells in a service bay before being inserted into the subsystem library or after being ejected from a data library in the subsystem. Whenever the service bay door is opened, the accessor is prevented from entering the service bay and tape cartridges may be inserted in the service bay storage cells or removed from the storage bay storage cells without pausing the subsystem.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a high input/output (I/O) capacity, multi-frame, preferred data storage subsystem;

FIG. 2 shows an example of block diagram of a preferred data storage system including the high I/O capacity storage subsystem;

FIG. 3 shows a flow diagram for an example of inserting/ejecting storage media in a high I/O capacity storage subsystem according to the present invention.

### DESCRIPTION OF PREFERRED EMBODIMENTS

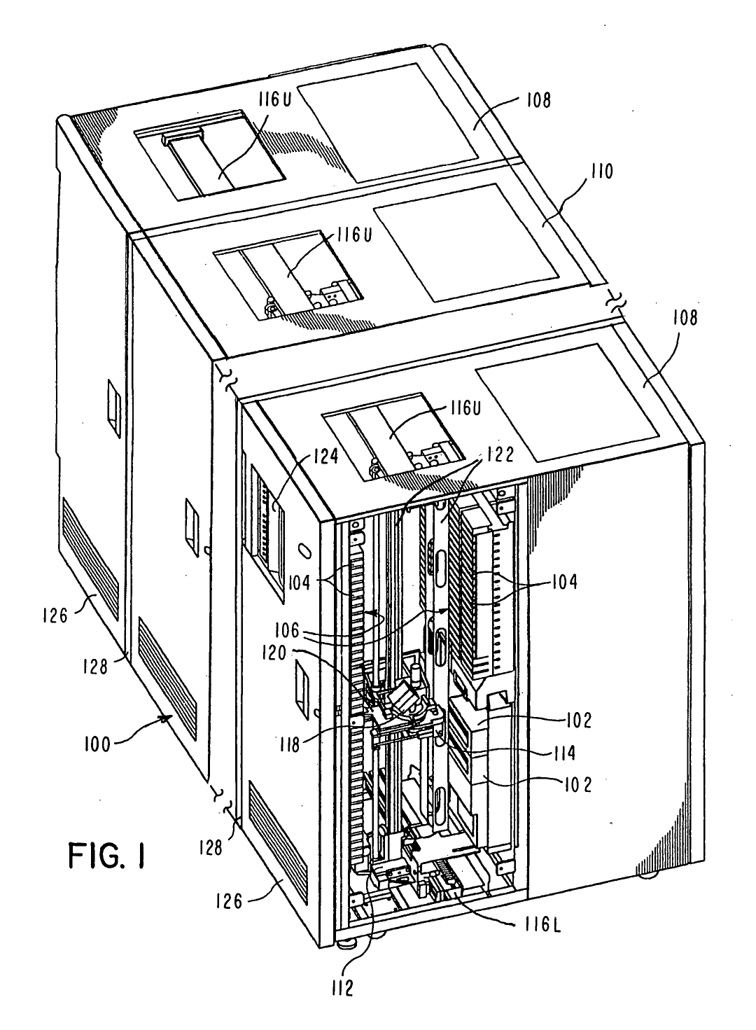

FIG. 1 shows an example of a high input/output (I/O) capacity, multi-frame, preferred data storage subsystem 100, such as an automated storage media (e.g., magnetic tape in tape cartridges) and retrieval library for storing and accessing storage media located within the subsystem. Although for simplicity of description, application of the present invention is described with reference to a tape cartridge storage subsystem 100, e.g., an IBM 3494 Tape Library Dataserver (IBM 3494), this is for example only. Thus, the present invention has application to any suitable storage subsystem with removable storage media. Further, storage media may be magnetic storage media such as magnetic tape, magnetic disk, optical storage such as compact disk (CD) or digital versatile disk (DVD), or any suitable equivalent non-volatile or volatile storage media.

In this example the data storage subsystem 100 includes one or more drive units 102 for reading and/or writing data on the physical volumes 104. As noted hereinabove and depending upon the particular storage media, the drives 102 can be optical disk drives or magnetic disk or tape drives. Correspondingly, the physical volumes 104 can be cartridges or cassettes containing optical or magnetic media (e.g., magnetic tape) or any other suitable removable media and associated drives. Typically, a single physical volume 104 can be individually addressed and accessed by a volume serial number, and a number of physical volumes or media cartridges 104 may be stored in storage cells in a storage rack 106. Service bays 108 (typically designated right and left) are disposed at either end of the subsystem 100, which includes one or more frames 110 between the service bays. The service bays 108 are capable of high capacity I/O, allowing bulk ejection and insertion, e.g., of up to 200 customer storage cells, without interfering with other customers storage cells (e.g., physical volumes 104 in storage rack 106 and within frames 110) for the high capacity I/O.

An automated system actuator assembly (at least one) including an accessor 112 and gripper 114, is slidably mounted on horizontal upper and lower rails 1 16U, 1 16L. The accessor 112 transports a selected physical volume 104 between storage cells in storage racks 106 and between the storage racks 106 and the drives 102. The cartridge gripper 114 grips and holds the selected physical volume 104 during transport. A bar code scanner 118, or similar visual input unit, is mounted on the gripper 114 to “read” labels identifying cartridges with a corresponding volume serial number. A teach sensor 120 is located on the gripper 114 with the bar code scanner 118. Lower rails 1 16L, typically plastic toothed rails (in a rack and pinion drive assembly), position the accessor 112 horizontally with respect to the storage rack 106. Vertical rail (a barber pole shaft (not shown)) and guide 122 position the gripper 114 vertically with respect to the storage rack 106. A manual I/O station 124 may be included in one of the service bay doors 126 for manual (operator) input and output of removable media for a small number (e.g., 10-20) of cells. During a high capacity I/O, a normally closed barrier door 128 between each of the service bays 108 and an adjacent frame 110 is open when cartridges are being removed from or placed in the service bay 108 by the accessor 112.

Advantageously, for inserting/ejecting a large number of volumes significant time savings is realized because the subsystem 100 is not paused to eject/insert the volumes and then returned to auto mode to process volume mounts and demounts. Instead, insertion and mounts/demounts are done on the fly as the subsystem 100 operates normally, seamlessly handling other customer volumes. Preferably, the high I/O capacity is defined in microcode that defines the service bays 108 as high I/O capacity stations. Additionally, the barrier door 128 may be defined to act as a safety interlock, preventing the accessor 112 from moving into the particular service bay 108 when the barrier door 128 is closed, e.g., by the operator for removing cartridges from or inserting cartridges into the service bay 108 by opening the service bay door 126.

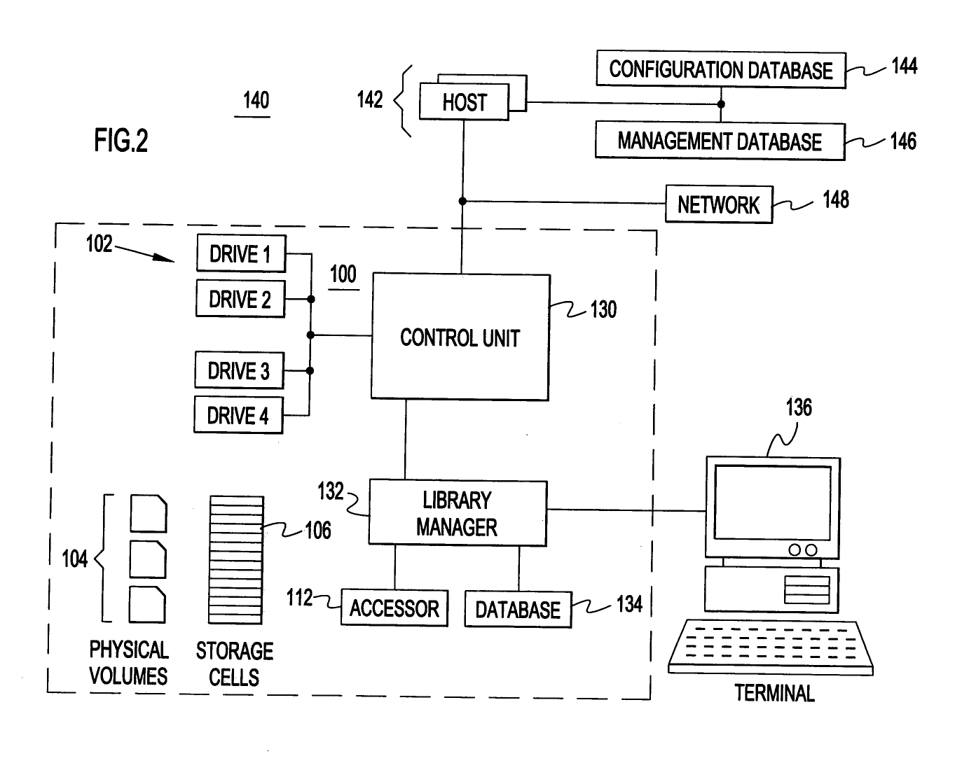

FIG. 2 shows a block diagram example of a preferred data storage system 140 including a high I/O capacity data storage subsystem 100, such as in the example of FIG. 1 in more detail with like elements labeled identically and, connected to one or more host system 142. The data storage subsystem 100 includes a control unit 130 and library manager (LM) 132. Preferably, the control unit 130 and library manager 132 are in software or firmware, e.g., in microcode stored in read only memory (ROM), running on a typical general purpose processor or processors, microprocessor(s) or embedded processor(s). The control unit 130 and library manager 132 control drive load/unload and related actions of drives 102, including high I/O capacity inserts/ejects. A library manager database 134 stores tables and programs for controlling the accessor 108 and includes a table that locates physical volumes 104 in the storage cells. An operator can communicate through operator console 136 with the library manager 132, which controls the accessor 112. The library manager 132 uses the library manager database 134 for controlling the accessor 112 in retrieving each selected physical volume 104 from its storage cell. Host system 142 sends requests through the control unit 130 to the library manager 132.

Each host system 142 typically includes a data storage system administration program managing a tape configuration database 144 and a tape management systems database 146. Also, typically, the host system 142 connects over a network 148 to other networked devices (not shown). The data storage system administration program uses the tape configuration database 144 to manage the volumes associated with each data storage subsystem 100 coupled to the particular host 142. The data storage system administration program uses the tape management system database 146 to manage data sets residing on the volumes, including the expiration, owner, access, etc. In addition, the tape configuration database includes a system volume catalog of other data relating to the volumes.

Thus, according to a preferred embodiment of the present invention, upon a high capacity eject, the library manager 132 controlling the active accessor 112 checks to whether the barrier door 128 is extended. If not extended the accessor 112 places the ejected cartridges in service bay storage cells in one of the storage racks 106. When the accessor 112 has completed transferring ejected cartridges to the service bay storage cells or, the storage racks 106 in the service bay 108 are full, a pop up may be displayed on the operator console 136 stating that ejected cartridges have been placed in the service bay 108 for removal. Thereafter, an operator may close the barrier door 128, which locks out the accessor 112 from the particular service bay 108 and, the operator may remove the cartridges from the service bay 108 by opening the service bay door. Then, the operator closes the service bay door 126 and opens the barrier door 128 and process more ejected cartridges. Similarly, to insert cartridges with the service bay door 126 closed, the operator closes the barrier door 128, opens the service bay door 126 and places the cartridges in the storage racks 106 in the service bay 108 for insertion. Then, the operator closes service bay door 126 and opens the barrier door 128, which triggers the control unit 130 to control the accessor 112 for removing and inserting the cartridges.

Provision may be made for allowing a customer engineer (CE) to work on the accessor 112 in the service bay 108 by placing the accessor in a service mode prior to opening the barrier door 128. In service mode, the subsystem operates as any typical storage subsystem, provided before the service bay door is extended the accessor is placed into service mode. In an implementation of the present invention in a 3494 Tape Library, for example, the accessor in the service bay being serviced is marked as being unavailable for high capacity input or output.

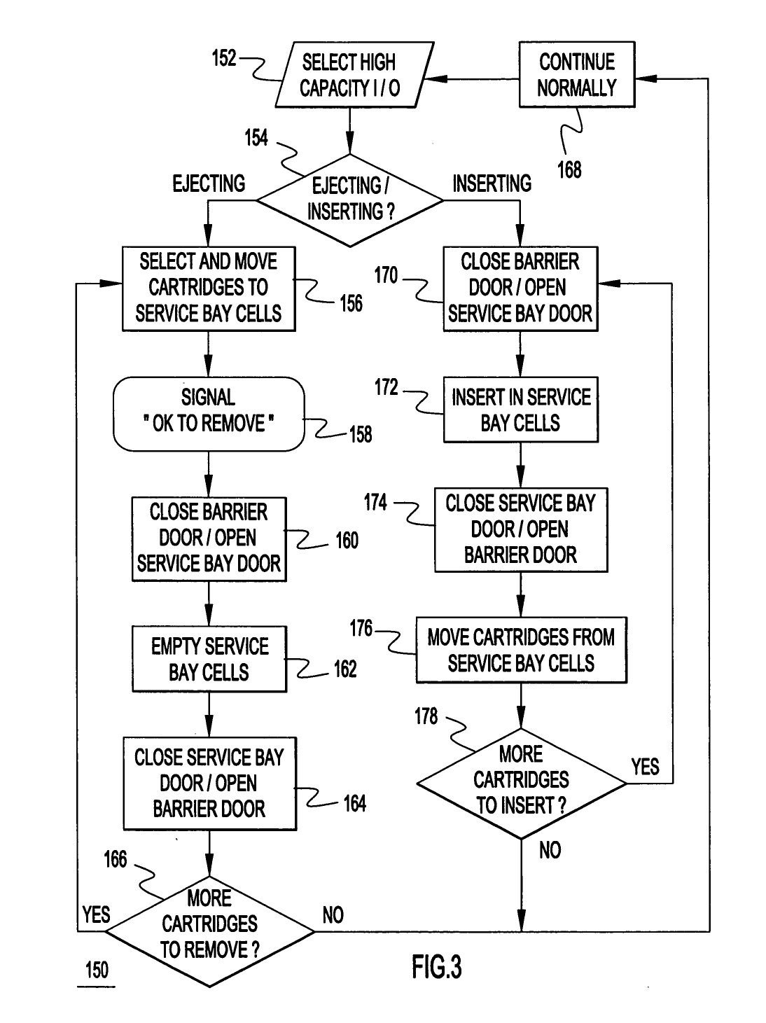

FIG. 3 shows a flow diagram example 150 of inserting/ejecting storage media in a high I/O capacity storage subsystem with reference to the subsystem 100 example of FIG. I and system example 130 of FIG. 2. First in step 152 high I/O capacity is selected. If cartridges are being ejected in step 154, then, in step 156 cartridges selected for ejection are moved to the service bay storage cells by the accessor 112. Once the storage bay cells are full or, all of the cartridges have been moved to storage bay cells, in step 158 an indication is provided that the cartridges may be removed from the service bay 108, e.g., with a pop-up on terminal 136. While the subsystem 100 continues to operate normally, i.e., does not pause, the operator closes the barrier door 128 in step 160, which prevents the accessor 112 from entering the service bay 108. In step 162, the operator opens the service bay door 126 to remove the cartridges. Once all cartridges have been removed and the service bay 108 is empty, the operator closes the service bay door 126 and opens the barrier door 128 in step 164. In step 166 a determination is made of whether more cartridges are yet to be ejected and, if so, returning to step 156 remaining cartridges are ejected. Once all selected cartridges have been ejected and removed in step 166, subsystem operation continues normally in step 168.

Similarly, if cartridges are being inserted in step 154, then the barrier door 128 is closed in 170 to prevent the accessor 112 from entering the service bay 108 and to signal the library manager 132 of the insertion. With the barrier door 128 closed in step 170, the operator opens the service bay door 128 and places cartridges in storage bay cells in step 172. Then, in step 174 the operator closes the service bay door 126 and opens the barrier door 128 and in step 176 the accessor 112 moves the cartridges from the service bay 108. Then, a determination is made of whether more cartridges remain for insertion in step 178. If additional cartridges remain for insertion, returning to step 170 the barrier door 128 is closed, the service bay door 126 is opened and additional cartridges are placed in service bay storage cells in step 172. Once all cartridges have been inserted in step 178, subsystem operation continues normally in step 168.

Advantageously, by continuing normal operation while inserting/ejecting volumes instead of pausing a preferred high I/O capacity storage subsystem, valuable system time is not wasted waiting for cartridge insertions and ejections. Furthermore, this improvement is achieved without increasing the subsystem footprint to consume additional space and power.

While the invention has been described in terms of preferred embodiments, those skilled in the art will recognize that the invention can be practiced with modification within the spirit and scope of the appended claims.

1. A method in a storage subsystem of providing storage media in physical storage volumes, said method comprising the steps of:
a) selecting high capacity input/output (I/O) for a storage subsystem;
b) opening a service bay door to a service bay;
c) transferring physical storage volumes to and from service bay storage cells in said service bay, said physical storage volumes being transferred to said service bay storage cells being inserted in said storage subsystem and said physical storage volumes being transferred from said service bay storage cells being ejected from said storage subsystem; and
d) closing said service bay door, said storage subsystem continuing to operate normally during said step (c) of transferring said physical storage volumes.

2. A method of providing storage media in a storage subsystem as in claim 1, wherein the step (b) of opening said service bay door signals an accessor to avoid entering said service bay and the step (d) of closing said service bay door signals said accessor that said service bay may be entered.

3. A method of providing storage media in a storage subsystem as in claim 1, wherein when the step (a) of selecting high capacity I/O selects ejecting storage volumes, step (a) further comprises the step of:
i) moving a plurality of physical storage volumes in said storage subsystem to corresponding said service bay storage cells; and
ii) signaling that said plurality of physical storage volumes may be removed from said corresponding service bay storage cells, said plurality of physical storage volumes being removed from said corresponding service bay storage cells in said transferring step (c).

4. A method of providing storage media in a storage subsystem as in claim 3, wherein the step (d) of closing said storage bay door comprises the step of:
i) determining whether more storage media remain selected for ejection responsive to a high capacity eject request in step (a); and
ii) returning to the step (a)(i) of moving a plurality of physical storage volumes to corresponding said service bay storage cells until all said storage media selected for ejection are found to have been ejected in step (d)(i).

5. A method of providing storage media in a storage subsystem as in claim 3, wherein after removing said plurality of physical storage volumes, the step (c) of transferring further comprises inserting storage media into said service bay storage cells for insertion into said storage subsystem.

6. A method of providing storage media in a storage subsystem as in claim 1, wherein when storage media is inserted into said service bay cells for insertion into said storage subsystem in the step (c) of transferring, said method further comprises the steps of:
e) moving said storage media from said service bay storage cells and inserting moved said storage media as a plurality of physical volumes in said storage subsystem;
f) determining whether more storage media are selected for insertion; and
g) returning to the step (b) of opening said service bay door until all said storage media selected for insertion are found in step (f) to have been inserted.

7. A method of providing storage media in a storage subsystem as in claim 1, wherein said storage media is magnetic tape and each of said physical storage volumes is disposed in a magnetic tape cartridge.

8. A method of providing storage media in a storage subsystem as in claim 7, wherein said storage subsystem is not paused responsive to said high capacity I/O request while said service bay door is open.

9. A computer program product for providing storage media in a high input/output (I/O) capacity storage subsystem, said computer program product comprising a computer usable medium having computer readable program code thereon, said computer readable program code comprising:
computer readable program code means for receiving high capacity input/output (I/O) requests for a storage subsystem;
computer readable program code means for blocking entry of an accessor into a service bay responsive to a service bay door open indication during a high capacity I/O; and
computer readable program code means for transferring physical storage volumes between service bay cells in said service bay and frames in said storage subsystem responsive to received said high capacity I/O requests.

10. A computer program product for providing storage media in a high input/output (I/O) capacity storage subsystem as in claim 9, wherein said computer readable program code means for transferring physical storage volumes comprises:
computer readable program code means for moving a plurality of selected said physical storage volumes from said frames to said service bay cells responsive to a high capacity eject request;
computer readable program code means for signaling moved said physical storage volumes are in said service bay cells; and
computer readable program code means for moving a plurality of inserted said physical storage volumes to said frames from said service bay cells responsive to a high capacity insert request.

11. A computer program product for providing storage media in a high input/output (I/O) capacity storage subsystem as in claim 10, further comprising:
computer readable program code means for determining whether more said physical storage volumes remain for transfer responsive to completion of transfer of said plurality of selected physical storage volumes or said plurality of inserted physical storage volumes.

12. A computer program product for providing storage media in a high input/output (I/O) capacity storage subsystem as in claim 11, wherein said storage subsystem is a high input/output (I/O) capacity, multi-frame, tape cartridge storage subsystem and said physical storage volumes are tape cartridges.

13. A high input/output (I/O) capacity, multi-frame storage subsystem for storing and administering data in a data library, said high I/O capacity, multi-frame storage subsystem comprising:
at least one service bay at one end of a plurality of storage frames, each of said storage frames containing a plurality of physical storage volumes in a data library;
a plurality of storage cells in said service bay;
a service bay door, selectively providing access to said plurality of storage cells; and
an accessor selectively moving one said plurality physical storage volumes between corresponding said frames and said plurality of storage cells, said service bay door being open preventing said accessor from entering said service bay.

14. A high I/O capacity, multi-frame storage subsystem as in claim 13, wherein said physical storage volumes are magnetic tape cartridges.

15. A high I/O capacity, multi-frame storage subsystem as in claim 14, further comprising:
a library manager controlling said accessor and maintaining a library manger database; and
a control unit controlling loading and unloading drives and related drive actions, said library manager preventing said accessor from entering said at least one service bay responsive to an indication that said service bay door is open.

16. A high I/O capacity, multi-frame storage subsystem as in claim 15, further comprising an operator I/O station, said control unit providing an indication on said operator I/O station that ejected tape cartridges have been placed in said storage cells in said at least one service bay for removal.

17. A storage system including a high I/O capacity, multi-frame storage subsystem as in claim 16, said storage system connectable to a network and further comprising:
at least one host system interfaced with said high I/O capacity, multi-frame storage subsystem;
a configuration database associating removable storage volumes in said storage subsystem coupled to said host system; and
a management database providing data management information for data on said removable storage volumes.
